(19) United States
(12) Patent Application Publication
(10) Pub. No.: US 2004/0044951 A1
(43) Pub. Date: Mar. 4, 2004

(54) Method for integration and reconciliation of electronic documents

(76) Inventors: John K. Repko, Evergreen, CO (US); Joseph S. Arokiaraj, Overland Park, KS (US); Alec Miller, Lawrence, KS (US); Tim Fite, Greenwood, MO (US); Kelly L. Babbit, Kansas City, MO (US)

Correspondence Address: POLSINELLI SHALTON & WELTE, P.C., 700 W. 47TH STREET, SUITE 1000, KANSAS CITY, MO, 64112-1802, US

(21) Appl. No.: 10/395,647

(22) Filed: Mar. 24, 2003

Related U.S. Application Data
(60) Provisional application No. 60/367,519, filed on Mar. 25, 2002.

(51) Int. Cl. G06F 17/00

(52) U.S. Cl. 715/500

(57) ABSTRACT

Methods and systems are disclosed for documents, created outside of a marketplace environment to be integrated and reconciled within a marketplace environment. This marketplace environment is typically a third party hosted environment. Also disclosed are methods and systems for creating invoices from order documents.

This application is related to and claims priority from U.S. Provisional Patent Application S/No. 60/367,519, filed on Mar. 25, 2002. U.S. Provisional Patent Application S/No. 60/367,519 is incorporated by reference herein.

### FIELD OF THE INVENTION

The present invention relates to a method for integrating and reconciling electronic documents. More specifically, the invention relates to a method for integrating and reconciling electronic representations of commercial documents not created within an electronic marketplace environment in which they are used, so that buyers and sellers in the marketplace environment have the ability to review, dispute, and resolve disputes, as well as execute payments between trading partners outside the marketplace environment.

### BACKGROUND OF THE INVENTION

Previous methods of integration and reconciliation have not allowed electronic representations of commercial documents created within the enterprise environment, to be integrated and reconciled in a marketplace or third party hosted environment. It is therefore desired to have a method of integration and reconciliation that allows integration and reconciliation of commercial documents not created within the electronic marketplace environment in which they are used.

Previous methods of integration and reconciliation have also not accommodated asynchronous (time-independent) integration and reconciliation of commercial documents. It is therefore desired to have a method of integration and reconciliation allowing for asynchronous integration and reconciliation of commercial documents.

Prior integration and reconciliation methods have not made it possible to extend an invoice management and payment application to buyers and sellers not otherwise interacting within a marketplace environment while not altering transactions taking place in the marketplace environment. It is therefore desired to have a method of integration and reconciliation allowing extension of a invoice management and payment application to buyers and sellers not otherwise interacting with a marketplace environment while not altering transactions taking place in the marketplace environment.

Previous methods of integration and reconciliation have not allowed buyers and sellers using a marketplace environment the ability to review, dispute, and resolve disputes, approve as well as pay and remit with trading partners not in the marketplace environment. It is therefore desired to have a method of integration and reconciliation allowing buyers and sellers using a marketplace environment the ability to review, dispute, and resolve disputes, approve as well as pay and remit with trading partners not in the marketplace environment.

Prior methods of integrating external documents into a marketplace environment have been observed to disrupt validation of documents already within the marketplace environment. External documents are documents produced outside the marketplace environment in which the documents are used for integration and reconciliation. It is thus desired to have a method of integrating external documents into a marketplace environment that does not disrupt validation of documents already within the marketplace environment.

It is thus desired to have a method making it possible for buyers and sellers not otherwise involved in a marketplace environment to conduct business and integrate with an invoice management and payment application. It is also desired to have a method having broad applicability in enabling commercial documents from a wide variety of disparate sources, including external buying and sourcing applications, use-specific clients, such as spreadsheets, designed to prepare and transmit commercial documents, and marketplace environments. It is additionally desired to have a method to integrate such sources with an invoice management and payment application without requiring the sources to integrate directly or synchronously with a payment application.

### SUMMARY OF THE INVENTION

The present invention relates to a method for integrating and reconciling electronic representations of commercial documents not created within the electronic marketplace environment in which they are used. The method allows buyers and sellers in the marketplace environment to have the ability to review, dispute, and resolve disputes, approve as well as pay and remit with trading partners outside the marketplace environment, in a third party hosted environment. Additionally, embodiments of the present invention provide methods of integration and reconciliation for electronic representations of commercial documents created within the enterprise environment, to be integrated and reconciled in a marketplace or third party hosted environment.

The present method enables invoices from sellers outside the marketplace environment to be used for payment with purchase orders created within the marketplace environment. The method also allows purchase orders from buyers outside the marketplace environment to be used for payment with invoices created within the marketplace environment. Additionally, the method provides for integration of purchase orders and invoices not created within a marketplace environment for use with an invoice management and payment application. The method also enables integration of external document sources without affecting the flow of documents in a marketplace environment. Finally, the method allows for convenient review and editing of documents entered asynchronously or incorrectly that are populated to suspense tables in an invoice management and payment application.

An embodiment of the invention is directed to a method for integrating documents. This method includes, obtaining an order document, for example, a purchase order (PO), from a purchaser enterprise system and writing this order document into an electronic format; obtaining an invoice document from a supplier enterprise system and writing this invoice document into an electronic format; and reconciling the order document and the invoice document in a third party hosted system. The order and invoice documents are typically created outside of a marketplace environment, while the reconciling is within a marketplace environment. This reconciling is typically performed electronically.

Another embodiment is directed to a system for integrating documents having a storage device and a processor. The processor is programmed to maintain in the storage device a database of at least one representation corresponding to an order document from a purchaser enterprise system; maintain in the storage device a database of at least one representation corresponding to an invoice document from a supplier enterprise system; and reconcile the at least one representation of the at least one order document and the at least one representation of the invoice document. This reconciliation results in an approval process where a payment process is invoked or a dispute process is invoked. In this dispute process, the issuer of the invoice document and the issuer of the order document or intended recipient of the invoice are placed into communication with each other, to ultimately move the invoice toward a payment mechanism, for example, an electronic settlement.

Another embodiment is directed to a computer-usable storage medium having a computer program embodied thereon for causing a suitably programmed system to integrate documents in a marketplace environment by performing the following steps when such program is executed on the system. These steps include maintaining a database of at least one representation corresponding to an order document from a purchaser enterprise system; maintaining a database of at least one representation corresponding to an invoice document from a supplier enterprise system; reconciling the at least one representation of the at least one order document and the at least one representation of the invoice document; and invoking an approval process or a dispute mechanism in response to the reconciliation of the at least one representation of the at least one order document and the at least one representation of the invoice document.

Another embodiment is directed to creating an invoice. This method includes obtaining at least one order document including at least one line item; electronically selecting at least one line item from the at least one order document to be used on the invoice; and electronically transferring the at least one line item into an invoice template. The at least one order document is for example, a purchase order (PO).

Another embodiment is directed to a system for integrating documents having a storage device and a processor. The processor is programmed to, maintain in the storage device a representation corresponding to at least one order document including at least one line item; select at least one line item from the at least one order document to be used on the invoice; and transfer the at least one line item into an invoice template.

Another embodiment is directed to a computer-usable storage medium having a computer program embodied thereon for causing a suitably programmed system to create an invoice document in a marketplace environment by performing the following steps when such program is executed on the system. These steps include, maintaining a representation corresponding to at least one order document including at least one line item; selecting at least one line item from the at least one order document to be used on said invoice; and transferring the at least one line item into an invoice template.

### BRIEF DESCRIPTION OF THE DRAWINGS

Attention is now directed to the attached drawings, wherein like reference numerals indicate corresponding or like components. In the drawings:

FIG. 1 is a flowchart showing a system architecture and environment in accordance with the present invention;

FIG. 2 is a flowchart showing a method for integrating and reconciling electronic documents in accordance with the present invention;

FIG. 3 is a diagram of an embodiment of the present invention in use in an exemplary application;

FIG. 4 is a flowchart showing an embodiment of the invention;

FIG. 5 is a flowchart of the approval process of FIG. 4;

FIG. 6 is a flowchart detailing a process of an embodiment of the invention; and

FIGS. 7-15 are screen shots in accordance with examples of embodiments of the invention.

### DETAILED DESCRIPTION OF THE DRAWINGS

The present invention relates to a process of integrating and reconciling commercial documents not created in a marketplace environment into an invoice management and payment application connected electronically to the marketplace environment. Embodiments of the invention are directed to web based matching and reconciliation between disparate, typically two, accounting systems, and commercial documents produced therefrom. These commercial documents can include, for example, purchase orders (PO's) and invoices.

Commercial documents are documents used in commercial sales and include such documents as purchase orders (PO's), invoices, receipts, order responses, purchase order acknowledgements, purchase order change requests, purchase order change acknowledgements, purchase order status requests, advance ship notices, advance ship notice acknowledgements, advance ship responses, change order requests, status checks, price/availability checks, remittance advice, electronic funds transfers, and forecasts. Documents, electronic documents, or electronic representations of documents refer to information stored on, or accessible via, a computer. This information may be a computer program, a text file, a Web page, or other computer-readable media.

Marketplace or marketplace environment refers to an electronic system that facilitates the purchase and sale of goods and services, principally through the creation and/or transmission of electronic documents between a buyer and a supplier, and subsequently into an invoice management and payment application. Invoice management application refers to an electronic means of reviewing electronic invoices for the purpose of review, dispute, dispute resolution, approval, payment and settlement. Payment application refers to an electronic means of reviewing electronic documents for the purpose of review, payment, and settlement of accounts within a marketplace environment.

Integration or integrating is a process by which electronic documents created either in the marketplace environment or outside the marketplace environment are evaluated and accepted, suspended, or rejected for processing by the marketplace, invoice management and payment applications. An electronic document that has been accepted for processing by an invoice management or payment application connected to the marketplace environment is integrated into an invoice management or payment application. The goal in integration is the creation and maintenance of a complete and consistent document set that 1) captures the essential features of the contract between buyer and seller, and 2) contains such supplemental information as is necessary to make the documents manageable by the buying application, selling application, and accounting systems within the buyer and seller. Selling application is any software that assists a seller in the offering of goods and services for sale by presenting content and by receiving and processing electronic documents received from the buying application of a buyer. Content refers to text, images, other media representations, and combinations thereof, containing features, specifications, and pricing of the product, service, or both, offered for sale.

Reconciliation or reconciling is a process by which complementary electronic documents are reviewed at a detailed level for compliance according to negotiated terms between seller and buyer. For example, the reconciliation process may include, but is not restricted to, line item part numbers match, where match refers to having values within agreed tolerances, line item quantities match, line item units of measure match, and line item prices match.

The method makes it possible to extend an invoice management and payment application connected to a marketplace environment to buyers and sellers outside the marketplace environment while not altering transactions taking place within the marketplace environment. The method may be used to offer buyers and sellers in the marketplace environment the ability to review, dispute, and resolve disputes, as well as pay and remit with trading partners outside the marketplace environment. A buyer is a business or individual that purchases, or desires to purchase, goods, equipment, or services from another company or individual. A seller or supplier is a business or individual that supplies, or desires to supply, goods, equipment, or services to another company or individual.

“Using the marketplace environment,” “in the marketplace environment,” or “in-marketplace” refers to events and entities directly participating in the marketplace environment such that an electronic document is generated within the marketplace environment. A buyer can be said to be “in the marketplace” if they use either a buying application to conduct business or the marketplace environment to route electronic documents. “In-marketplace” is meaningful to the process of integration to a payment application because in-marketplace electronic documents carry identifiers such as buyer and seller identification assigned in a buying application and selling application. If in-marketplace, then this information is already available to the payment application.

“Outside the marketplace environment” or “out-of-marketplace” refers to events and entities not directly participating in the marketplace environment such that an electronic document is not generated within the marketplace environment. A buyer outside the marketplace environment will not use either a buying application or the marketplace environment to route electronic documents. For such a buyer outside the marketplace environment, the only contact with the marketplace environment is through an invoice management or payment application. For out-of-marketplace, an electronic document is stored until the matching complementary electronic document, for example the invoice which corresponds to a particular purchase order, appears for integration, until which point as there is not sufficient information for the integration to take place. Thus, in-marketplace electronic documents are integrated immediately, whereas out-of-marketplace documents are stored until a complementary electronic document is matched and then integrated.

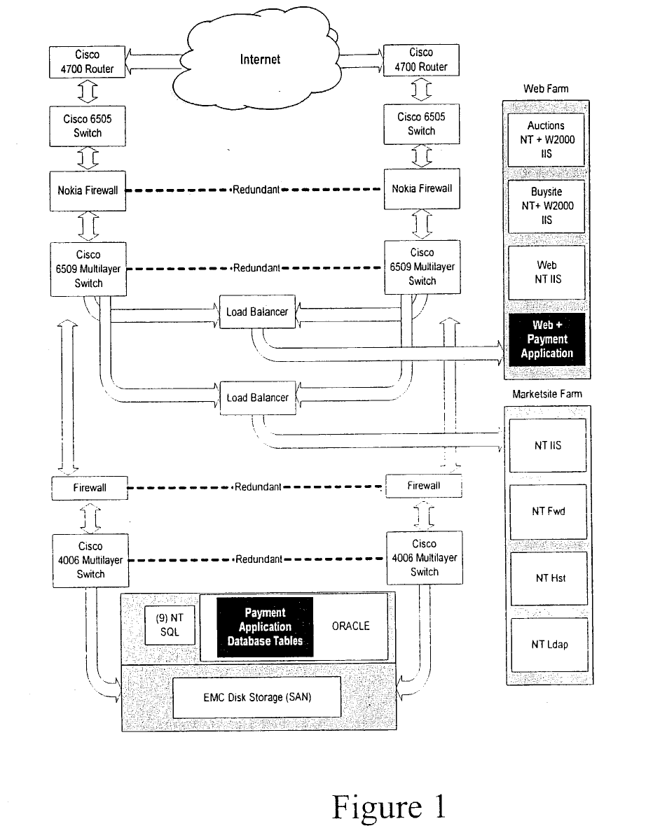

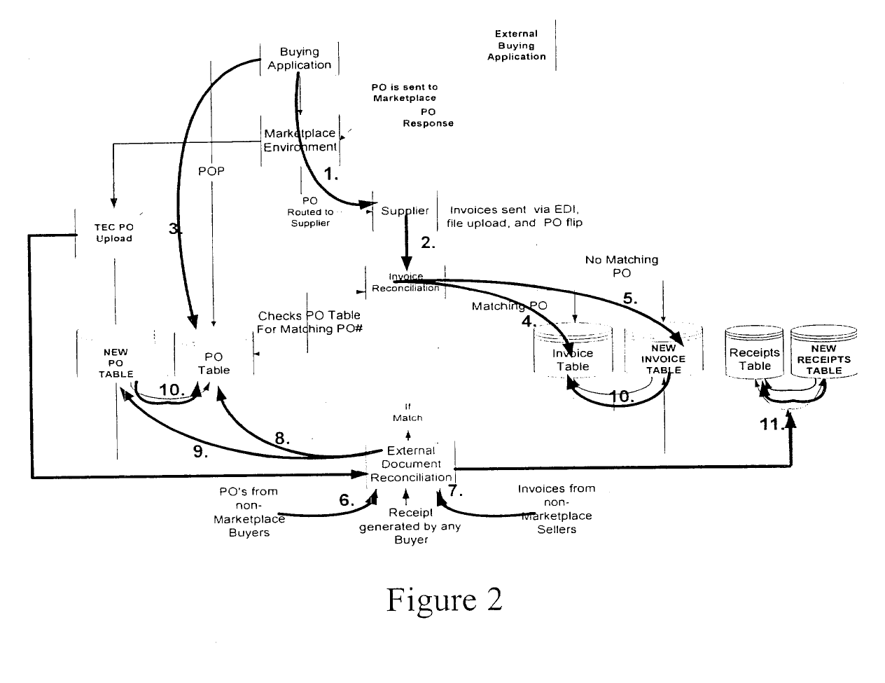

Although the method was developed on an Oracle® database running on Sun® E450 server hardware and EMC® Symmetrix® disk hardware running the Solaris® operating system, other compatible systems may be used. The software for the present method was developed using the Java programming language, but other languages may be used. FIG. 1 indicates an appropriate system architecture and environment for the present method.

In the present method, users of a buying application create purchase orders that are routed via the marketplace from the buying application to sellers, who fulfill the orders 1, FIG. 1. Buying application is any software that assists a buyer in the procurement of goods and services by creating electronic documents and then electronically transmitting the electronic documents from the buying application to sellers, who receive and process the electronic documents.

Sellers deliver invoices 2, using existing EDI software, or by using either a web application or template upload application. An invoice is a bill issued by a business or individual that has or will have provided products, services, or both to a customer. EDI software is any software that is used for the purpose of creating, transmitting, routing, receiving, or translating documents that conform to the IEEE x.12 specification for electronic documents interchange.

Purchase order documents are copied from the buying application to the invoice management and payment application via a process known as purchase order push (POP). A purchase order, or PO, is an authorization for a supplier to ship products at a specified price, and which generally becomes a legally binding contract once the supplier accepts it. Purchase order documents can be transferred via a POP from the buying application at any time, either synchronously or asynchronously. Such documents are stored in a database table known as the payment PO table within the invoice management and payment application, 3.

Invoice documents are captured in several different input formats. Each invoice document submitted must contain a PO number, and if a PO corresponding to the PO number on the invoice can be found in the payment PO table, then the invoice will be populated into a database table termed the payment invoice table for later reconciliation, payment, and settlement via the invoice management and payment application, 4.

If no corresponding PO can be found, then the invoice is stored in a database suspense table where it is stored until a matching PO is obtained, 5.

A matching PO may be obtained via a POP from the buying application, extracted from the transaction event collector or other document-tracking utility in the marketplace environment, or submitted independently of the buying application, 6.

When a PO, invoice, receipt, or other document is submitted (each document termed a submitted document) from outside the marketplace environment, an independent reconciliation process matches the submitted document to its complement (for example, invoice for PO, PO for invoice, and PO for receipt or other document) residing in the payment application processing tables, 7.

If a matching complementary document is found, the submitted document is populated to the appropriate payment table for later reconciliation, payment, and settlement in the payment application, 8. Complementary documents or complementary electronic documents are a set of documents, which must be viewed together in order to complete a transaction for accounting purposes. For example, regarding an invoice which corresponds to a purchase order for a particular transaction, the invoice and purchase order are complementary documents.

If no corresponding complementary document can be found, then the submitted document is stored in a database suspense table until a matching complementary document is obtained, 9.

Each reconciliation process can run synchronously (with the arrival of a new PO or invoice document from any source) or asynchronously (via batch or cron job) to try to match documents in advance of migrating matching documents to their respective tables. A cron job means setting a specific action or series of actions to take place at a specific time, or periodically at a specifically designated interval.

When the matching process links an invoice, receipt, or other document to a matching PO, the matched document is migrated from the suspense table to its proper payment document table for processing by the payment application, 10.

Additional documents such as receipts are added to the payment application by extending the model. For example, receipt documents are also captured from their various input formats. Each receipt submitted must contain a PO number, and if a PO corresponding to the PO number on the receipt can be found in the payment application PO table, then the receipt will be populated into a database table for later reconciliation, payment, and settlement in the payment application, 11.

If no corresponding PO can be found, then the receipt is stored in a database suspense table until a matching PO is obtained, 12.

Documents held in suspense tables for payment application documents can be made available for editing by the producer of the document in suspense within the payment application, with the appropriate reconciliation process triggered or run batchwise following the completion of editing of the suspensed document.

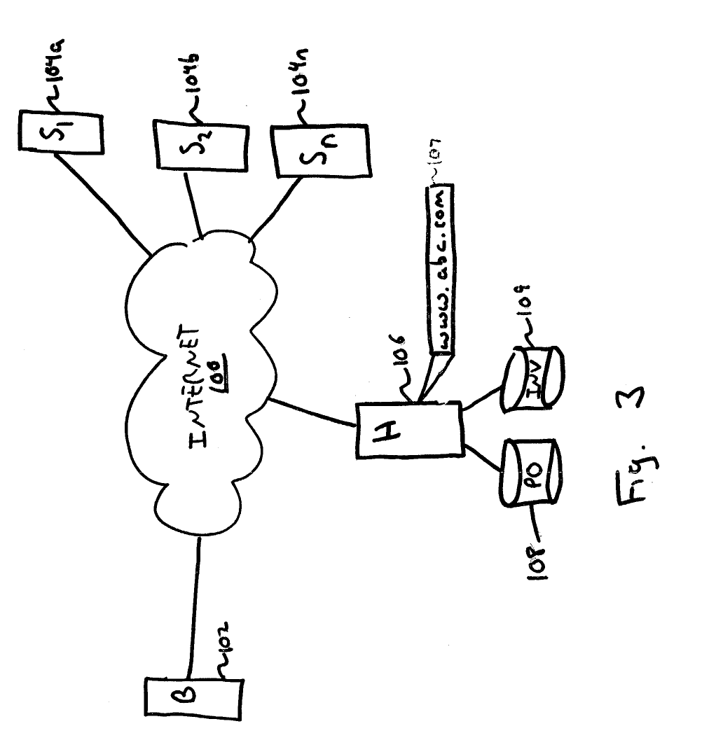

FIG. 3 shows an exemplary system, on which embodiments of the invention can be performed. Typically, the embodiments described herein are employed with a wide area network (WAN), for example, the Internet 100. Connecting to the Internet 100, for example are a computing device 102 (or devices) of a buyer (B), with one or more processors or microprocessors, this computing device typically being, a server, multimedia personal computer (for example, Pentium® based), workstation, or the like. Also connected to the Internet 100 are computing devices 104a, 104b, 104n of Sellers (S₁-Sₙ-representative of multiple sellers on the network). These computing devices 104a-104n are in accordance with those detailed immediately above.

A host server (H) 106 or third party server (with an address of www.abc.com, for description purposes, at block 107), or other similar computing device (similar to that detailed above), that performs embodiments of the present invention, as detailed herein, connects to the Internet 100. This server 106, for example, includes one or more processors or microprocessors, and also includes (internally or externally) structure, for example, storage media, for supporting databases, for example, for purchase orders 108 and invoices 109 (shown outside of the server 106 for emphasis).

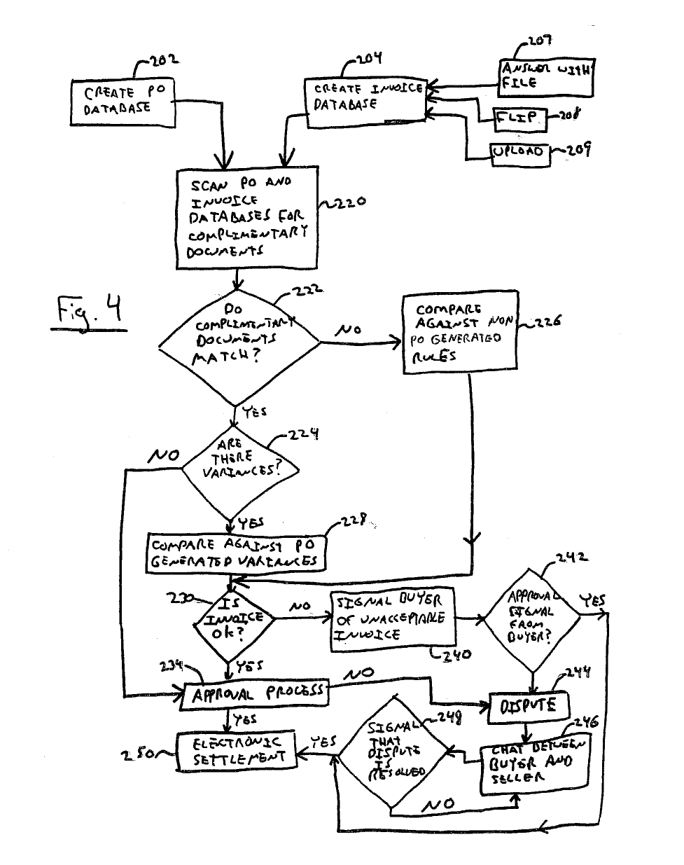

FIG. 4 details a flowchart of an embodiment of the present invention. Initially, a database for purchase orders (POs) 108 (FIG. 3) is created, at block 202, and a database for invoices 109 (FIG. 3) is created, at block 204. These databases are typically created independently of each other, however, as detailed below, there are instances when an invoice will be created directly as result of a PO entering the PO database, here, for example, from the buyer's computing device 102.

POs are created as detailed above, or any other way known in the art. For example, a PO is typically uploaded into the database and written into the database. The writing process separates the components of the PO into fields, that populate the database. These fields can be selected by the users, with exemplary fields including: PO number, supplier part number, manufacturing part number, unit of measure, quantity, amount, short description, cost center, shipping information, tax, amount per item. POs can be created by any known software, for example, customer procurement applications from SAP®, PeopleSoft®, Oracle®, CommerceOne®, Ariba®, as well as ProcureScout^{SM}, a web based interface from ESCOUT, Inc., 850 NW Chipman Road, Lees Summit, Mo. 64063, that provide electronic PO documents in formats such as xCBL, CXML (commerce extensible markup language), CSV (comma separated values) and UBL (universal business language) from Oasis®.

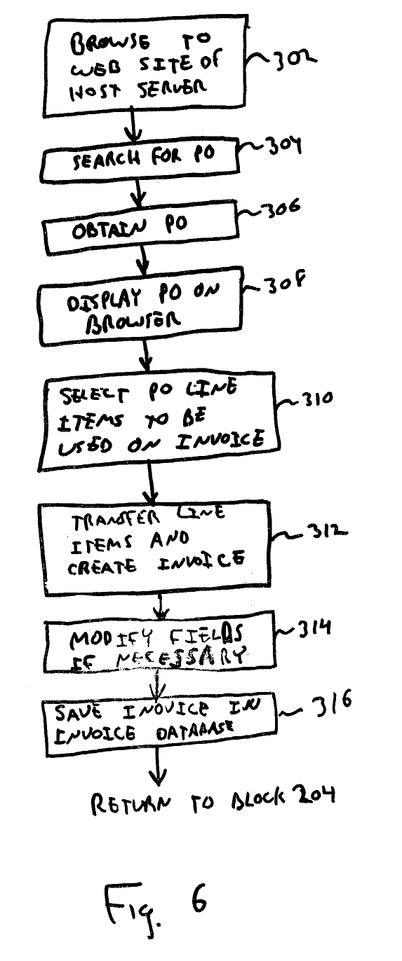

Invoices are created as detailed above, and here, for example, in the computing devices 104a-104n of the sellers. These invoices are created using for example EDI software, or by other processes. The invoice can be created, for example, as an answer in response to a PO entering the PO database, block 207 or with a process in accordance with Flexible Invoicing Software, a web-based interface from ESCOUT, Inc. (detailed herein at FIG. 6), block 208. These two exemplary methods for directly creating an invoice are typically real-time based, but can also be performed off-line.

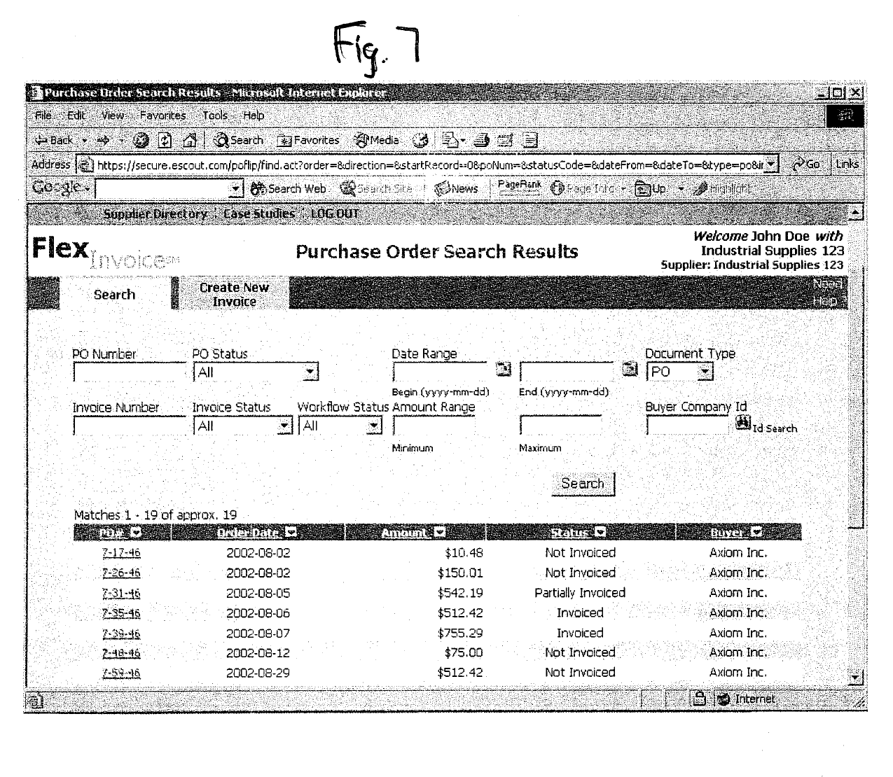

Turning to FIG. 6, there is shown a process in accordance with the Flexible Invoicing Software, described above, at block 208. The process begins, as the user, here the supplier (for example, corresponding to one of computing devices 104a-104n), goes to the World Wide Web (WWW), and sets their browser to the web site corresponding to the host server (H) 106, here for example, the address www.abc.com, at block 302 to obtain a GUI (for example, the screen shot of FIG. 7), from where they will access the requisite PO, at block 304. The user typically searches for the requisite PO based on one or more fields, for example, PO Number, PO status, Date Range. The PO is then retrieved from the PO Database 108, at block 306, and displayed on the user's browser, at block 308.

With the PO now on their browser and monitor (here, for example, computing device 104a-104n corresponding to the user), the user selects the PO line items to be included on their invoice, at block 310. These line items are transferred to, for example, an electronic invoice template or other similar electronic document (that will result in an Invoice) or representation thereof (for example, stored in a storage device either external or internal to the host server 106) so as to be “flipped” onto an invoice, and displayed in the user's browser (and monitor) at block 312.

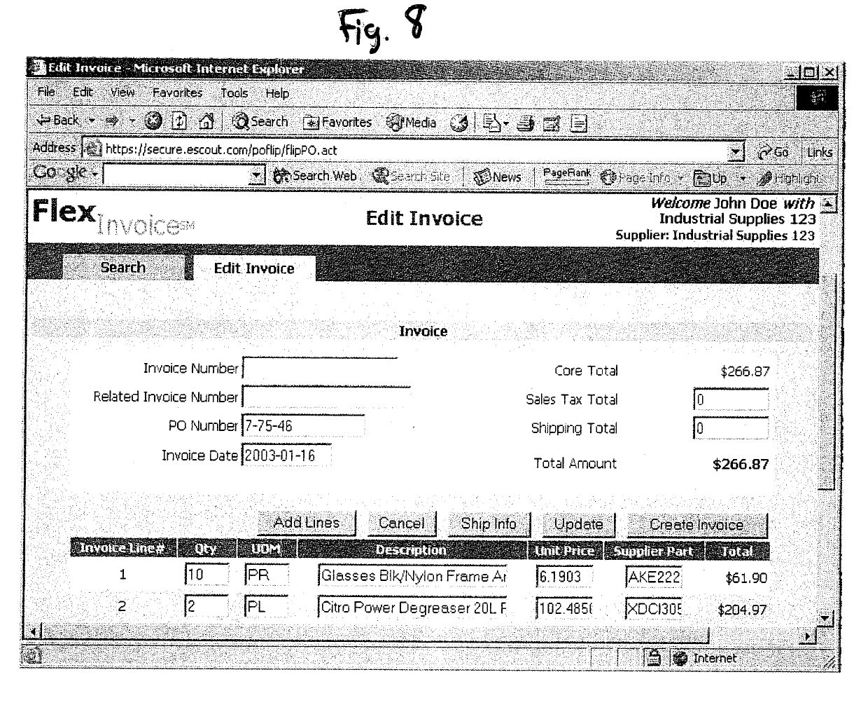

With the invoice now created, the user can modify the fields of the invoice (for example, by accessing the GUI of the screen shot of FIG. 8), before saving the invoice in the invoice database 109, at block 314. These fields include, for example, supplier part number, manufacturing part number, unit of measure, PO Number, Quality, Unit of Measure, Description, Unit Price, Supplier Part Number, Sales Tax Total, Shipping Total, Invoice Number. The invoice is now saved in the invoice database 109, at block 316, and the process resumes at block 204.

Invoices can also be uploaded into the system by vendors or other service providers, at block 209. These invoices can come from service providers using their own software that will provide standard invoice documents. Such software is available for customer procurement applications from, for example, SAP®, People Soft®, iProcure®, Oracleo®, CommerceOne®, Ariba®, in accordance with document standard formats such as xCBL, CXML, CSV and UBL, as detailed above.

These invoices, once provided to the database, are written into the database 109. The writing process separates the components of the invoice into fields, that populate the database. These fields are typically in accordance with the fields listed above for PO's, and additionally including invoice number, with at least one, and typically multiple, corresponding fields, so that documents (PO's and invoices) can be matched for reconciliation.

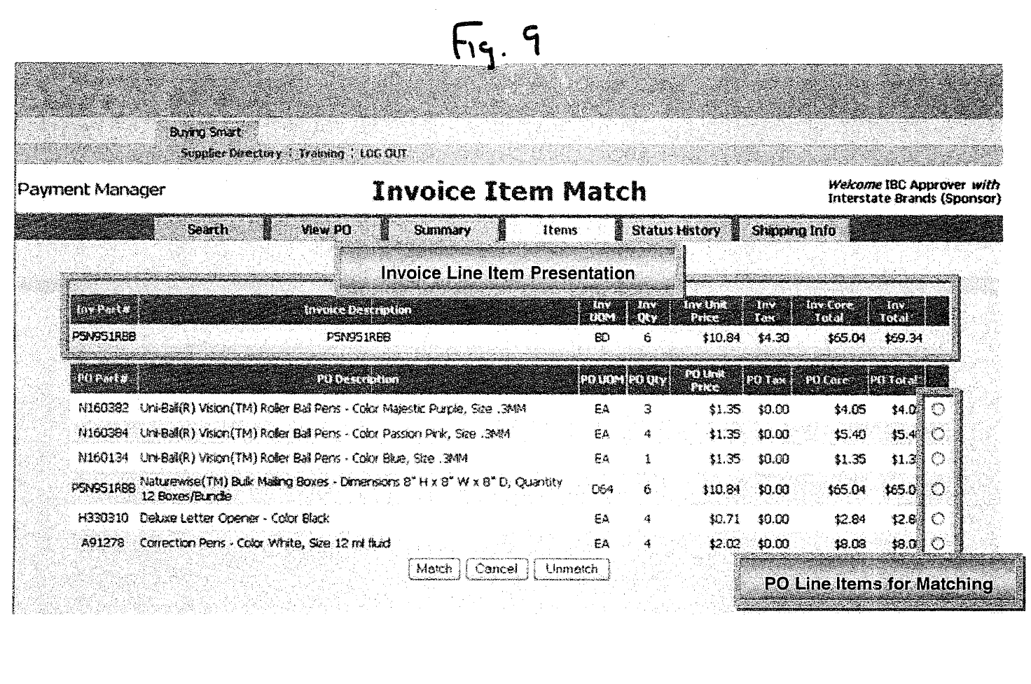

The databases 108, 109 (FIG. 3) are then scanned (searched) for complimentary POs and invoices, at block 220, typically by using comparison software, that, for example, compares corresponding fields in the respective POs and invoices. It is then determined if the complimentary documents, for example, PO and Invoice here, match, at block 222. A match is determined in accordance with user defined rules. For example, FIG. 9 shows a screen shot where an invoice is matched in accordance with PO line items. The reconciliation process begins at block 222 and, for example, ends in the approval process, at block 234 (and blocks 270-282), as described herein.

If a match occurred, at block 222, the Invoice (fields) are checked for variances for that particular PO, at block 224. The checking for variances is performed, for example, with comparison software or the like. This situation typically occurs with invoices that are entered into the invoice database in response to contracts or for services performed, that do not have a matching PO, as they were not created as the result of a PO in the system.

If a match did not occur, at block 222, the invoice is compared against non-PO generated rules, at block 226, and the process moves to block 234, the approval process, as detailed below. These non-PO generated rules may be directed to, for example, amounts, approved suppliers, approved account codes, etc.

Returning to block 224, if there are not any variances, the process moves to block 230. If variances are detected, they are compared against PO generated variances, at block 228. These PO generated variances are in accordance with user generated rules. These variances can be, for example, differences at the line item layer, differences in the total amount.

The process now moves to block 230, where it is determined if the invoice is suitable for the approval process, at block 234. An invoice is, for example, not suitable, should it fall outside of the non-PO generated rules (block 226), or outside of the PO generated variances (block 228). Conversely, an invoice is suitable for the approval process if, for example, if it falls inside of the non PO generated rules (block 226), inside of the PO generated variances (block 228), or if there are not any variances (block 224).

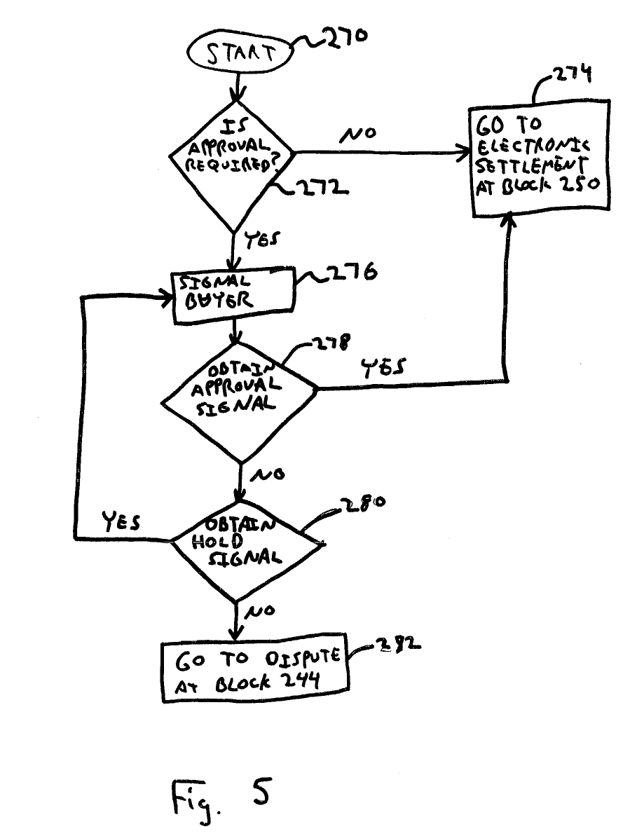

If the invoice is sufficient, it is passed to an approval process, at block 234. The approval process of block 234 is shown in detail in FIG. 5, and described in detail below.

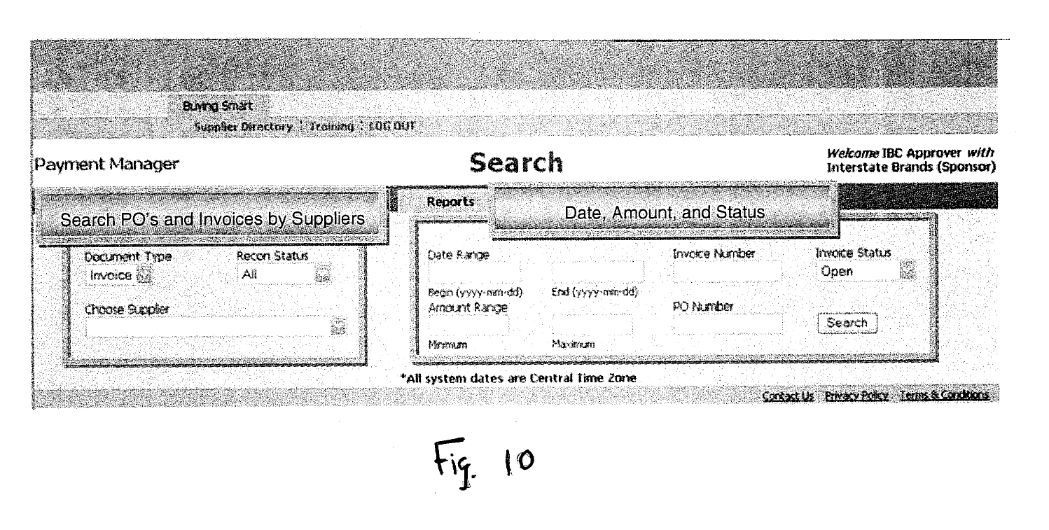

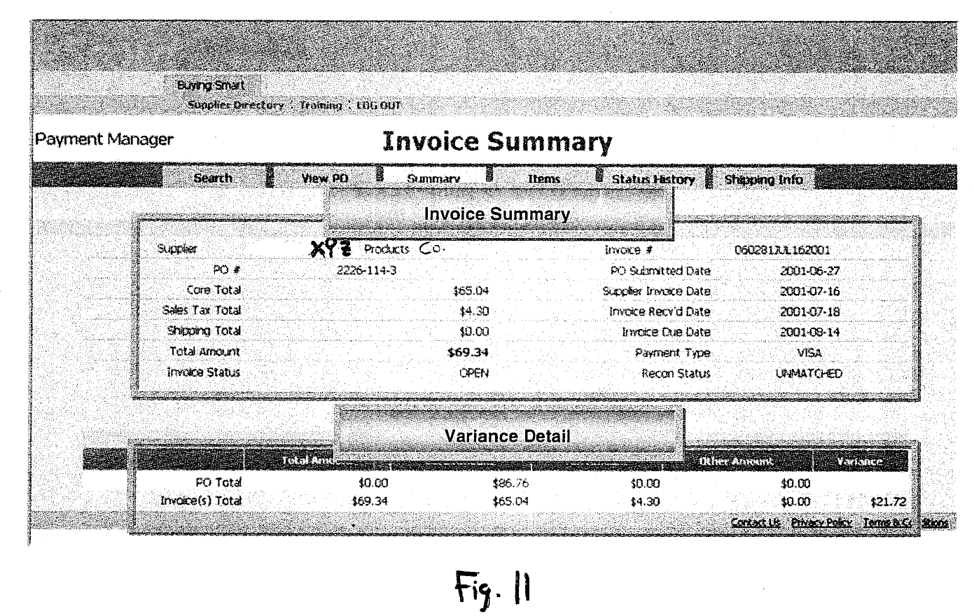

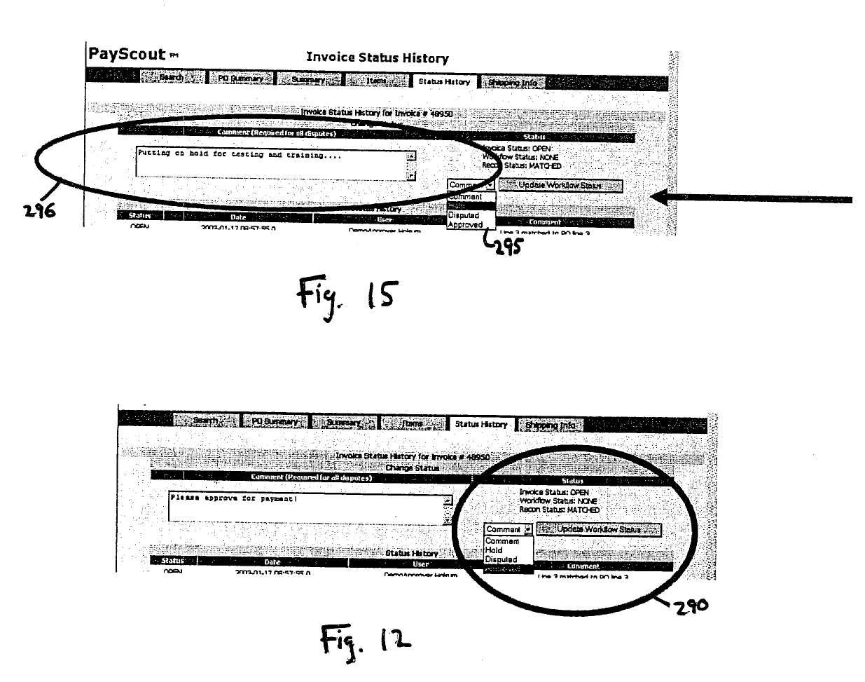

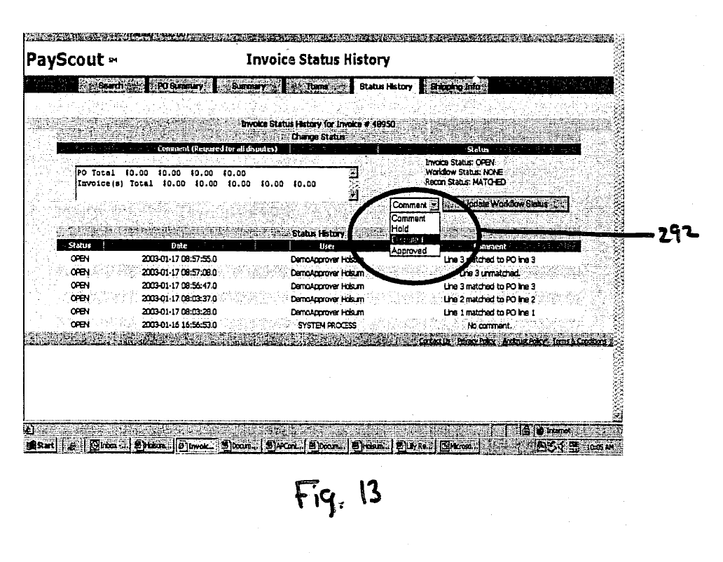

If the invoice is not sufficient, the buyer (who has not issued a PO or the like in the case where the process comes from block 226, and is therefore, a receiver (or intended recipient) of the invoice without a PO) or issuer of the PO, is notified, typically electronically, at block 240. This notification is typically over the internet 100, from the host server 106 to the computing device 102 of the buyer. The buyer then calls up a user interface (for example, through computing device 102), for example a graphical user interface (GUI) (for example, in accordance with the screen shot of FIG. 10), typically via the World Wide Web or other network, corresponding to the host server (H) 106 (FIG. 3) (here for example, by directing their browser to the address www.abc.com to access the host server 106) and obtains the requisite invoice, as shown in the screen shot of FIG. 11. The obtained invoice can now be approved (as shown, for example, by the screen shot of FIG. 12, within the circle 290) or disputed (not approved) (as shown, for example, by the screen shot of FIG. 13, within the circle 292), and as indicated by the receipt of a signal from the buyer at block 242. Typically, through the GUI, the user will send the approval or non approval signal back to the host server (H) 106, FIG. 3.

Where the invoice was approved, or edited and approved, the process moves to block 250, where a payment process or payment mechanism, typically in the form of an electronic settlement is made. During electronic settlement, for example, electronic payment instructions are created and processed, typically by automated clearing house (ACH) software, or other conventional electronic payment system.

Where the invoice was not approved as detailed above, at block 242, the process invokes a dispute mechanism, at block 244. Here, the system, for example, in the host server (H) 106 and/or its associated software and hardware, records a dispute, for example, by recording data corresponding to invoice numbers, time, purpose, and stores them in a database, typically the invoice database 109.

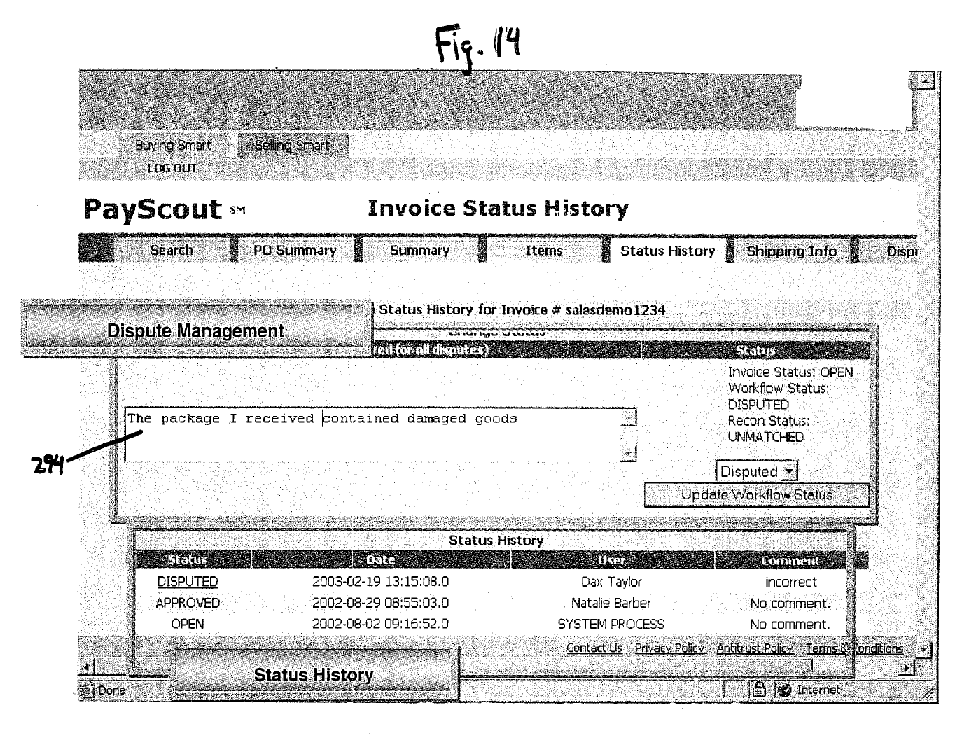

Typically, this dispute mechanism places the buyer (for example, through computing device 102), who issued the PO, into a communication, typically an electronic chat (typically in real time) over the Internet 100, with the seller (for example, through the requisite computing device 104a-104n), who issued the invoice, at block 246. For example, a dispute over the goods has been indicated by an entry at box 294 of the screen shot of FIG. 14. This electronic chat may be in accordance with any of the known chat or chat room programs. Alternately, the buyer's comments can be recorded in a discussion board for retrieval by the seller, who responds to this online dispute.

A signal is then received, at block 248, as to the chat resolving or not resolving the dispute. If a positive signal is received, that the chat resolved the dispute, and the invoice is approved, the process moves to block 250, where an electronic settlement is made, as detailed above. Should a negative signal be received, at block 248, and the dispute not resolved, the process returns to block 246, where it typically continues until resolution and electronic settlement, at block 250.

Turning back to block 232, and FIG. 5, the approval process is now discussed in detail. The start of the process is at block 270. Initially, in accordance with user generated rules, it is determined if approval of the invoice is required, at block 272. If approval is not required, as the invoice falls within the rules, the process moves to electronic settlement of block 250, at block 274.

If approval is required, as the invoice falls outside of the rules, at block 272, the buyer (or issuer of the PO) is notified, typically electronically, as detailed above, at block 276. Similar to that detailed above, the buyer will access the GUI of the host server (H) 106 (FIG. 3), and pull up the invoice. Similar to that detailed above, the buyer, through the GUI (see the screen shots of FIGS. 12 and 13), will indicate approval or disapproval of the invoice through the GUI, that will send a signal corresponding to the approval or disapproval of the invoice, that is obtained by the home server at block 278.

If an approval signal is obtained by the host server (H) 106 (FIG. 3) at block 278, the process goes to the electronic settlement of block 250, at block 274. If a disapproval signal is obtained by the host server (H) 106 (FIG. 3) at block 278, another query is made to see if the buyer issued a hold signal, at block 280. For example, the buyer can create a hold signal through the GUI as shown in box 295 of the screen shot of FIG. 15 (with additional comments within the circle 296). If so, the invoice will be held, typically in the invoice database 109 (FIG. 3), and after a preset time in the database, the process returns to block 276, where the buyer is again notified of this held invoice. If the invoice is not to be held, as a signal not to hold the invoice was received (obtained, for example, by the host server 106), the process goes to the dispute mechanism of block 244, at block 282.

The process from block 222 through electronic settlement, block 250 can be run either synchronously (with the arrival of a new PO or invoice document from any source) or asynchronously (via batch or cron job) to try to match documents in advance of migrating matching documents to their respective tables, as detailed above.

The processes described above, all or portions thereof, can be embodied in programmable storage devices readable by a machine or the like, or other computer-usable storage medium, including magnetic, optical, or semiconductor storage, or other source of electronic signals. Some computer-usable storage media include discs, such as magnetic and compact discs (CDs) and the like.

The processes (methods) (including sub-processes) and systems (including components) described herein have been described with exemplary reference to specific hardware and/or software. These methods have been described as exemplary, whereby specific steps and their order can be omitted, and/or changed by persons of ordinary skill in the art to reduce embodiments of the above disclosed processes and systems to practice without undue experimentation. The processes and systems have been described in a manner sufficient to enable persons of ordinary skill in the art to readily adapt other commercially available hardware and/or software as may be needed to reduce any of the above disclosed embodiments to practice.

Thus, there has been shown and described a process for integrating and reconciling electronic documents. It is apparent to those skilled in the art, however, that many changes, variations, modifications, and other uses and applications for the above described embodiments are possible, and also such changes, variations, modifications, and other uses and applications which do not depart from the spirit and scope of the invention are deemed to be covered by the invention, which is limited only by the claims which follow.

What is claimed is:

1. A method for integrating documents comprising:
obtaining an order document from a purchaser enterprise system and writing said order document into an electronic format;
obtaining an invoice document from a supplier enterprise system and writing said invoice document into an electronic format; and
reconciling said order document and said invoice document in a third party hosted system.

2. The method of claim 1, wherein said order document is created outside of a marketplace environment.

3. The method of claim 1, wherein said invoice document is created outside of a marketplace environment.

4. The method of claim 1, wherein said reconciling is within a marketplace environment.

5. The method of claim 1, wherein said reconciling is performed electronically.

6. The method of claim 1, additionally comprising:
creating a first database by said writing said order document into an electronic format;
creating a second database by said writing said invoice document into an electronic format; and
scanning said first and second databases for complimentary documents.

7. The method of claim 6, wherein said reconciling includes:
determining if there are complimentary documents; and
if said complimentary documents exist, determining if said invoice document falls within predetermined variances set for said complimentary order document.

8. The method of claim 7, wherein if said invoice document is within said predetermined variances, submitting said invoice document to an approval process.

9. The method of claim 8, wherein said approval process includes determining if said invoice is suitable for payment.

10. The method of claim 9, wherein if said invoice is suitable for payment, invoking an electronic settlement mechanism.

11. The method of claim 9, wherein if said invoice is not suitable for payment, invoking a dispute mechanism.

12. The method of claim 11, wherein said dispute mechanism includes: a process for placing the issuer of said order document into communication with the issuer of said invoice document, and a process for indicating the status of said dispute.

13. The method of claim 1, wherein said order document includes a purchase order.

14. The method of claim 7, wherein if said invoice document is not within said predetermined variances, providing a signal to the issuer of said complimentary order document that said complimentary invoice is unacceptable.

15. The method of claim 14, additionally comprising: obtaining a first signal and invoking a dispute mechanism or obtaining a second signal and invoking a payment mechanism.

16. The method of claim 15, wherein said dispute mechanism includes: a process for placing the issuer of said order document into communication with the issuer of said invoice document, and a process for indicating the status of said dispute.

17. The method of claim 15, wherein said payment mechanism includes an electronic settlement.

18. The method of claim 6, wherein said reconciling includes:
determining if there are complimentary documents; and
if said complimentary documents do not exist, comparing said invoice against a predetermined set of rules.

19. The method of claim 18, wherein if said invoice is within said predetermined set of rules, submitting said invoice to an approval process.

20. The method of claim 18, wherein if said invoice is not within said predetermined set of rules, providing a signal to the receiver of said invoice that said invoice is not within said predetermined set of rules.

21. The method of claim 19, wherein said approval process includes determining if said invoice is suitable for payment.

22. The method of claim 21, wherein if said invoice is suitable for payment, invoking an electronic settlement mechanism.

23. The method of claim 21, wherein if said invoice is not suitable for payment, invoking a dispute mechanism.

24. The method of claim 23, wherein said dispute mechanism includes: a process for placing the issuer of said order document into communication with the issuer of said invoice document, and a process for indicating the status of said dispute.

25. A system for integrating documents comprising:
a storage device; and
a processor programmed to:
maintain in said storage device a database of at least one representation corresponding to an order document from a purchaser enterprise system;
maintain in said storage device a database of at least one representation corresponding to an invoice document from a supplier enterprise system; and
reconcile said at least one representation of said at least one order document and said at least one representation of said invoice document.

26. The system of claim 25, wherein said processor programmed to reconcile includes:
analyzing said at least one order document for its being complimentary to said at least one invoice document;
analyzing said complimentary documents for variances; and
if variances do not exist or are within predetermined rules, submitting said invoice document to an approval process.

27. The system of claim 25, wherein said processor programmed for invoking said approval process includes determining if said at least one invoice document is suitable for payment.

28. The system of claim 27, wherein said processor programmed for determining if said at least one invoice document is suitable for payment, includes invoking an electronic settlement mechanism.

29. The system of claim 25, wherein said processor programmed to reconcile includes:
analyzing said at least one order document for its being complimentary to said at least one invoice document;
analyzing said complimentary documents for variances; and
if variances exist and are within predetermined rules, providing a signal to the issuer of said at least one complimentary order document that said at least one complimentary invoice document is unacceptable.

30. The system of claim 29, wherein said processor is additionally programmed to: obtain a first signal and invoke a dispute mechanism or obtain a second signal and invoke a payment mechanism.

31. The system of claim 30, wherein said processor programmed to invoke a dispute mechanism includes: a process for placing the issuer of said at least one order document into communication with the issuer of said at least one invoice document, and a process for indicating the status of said dispute.

32. The system of claim 30, wherein said payment mechanism includes an electronic settlement.

33. The system of claim 25, wherein said processor programmed to reconcile includes:
analyzing said at least one order document for its being complimentary to said at least one invoice document; and
if said at least one order document is not complimentary to said at least one invoice document;
analyzing said at least one invoice document in accordance with predetermined rules.

34. The system of claim 33, wherein said processor programmed for analyzing said at least one invoice document in accordance with said predetermined rules includes:
providing a signal to the intended recipient of said at least one invoice document that said at least one invoice document is unacceptable, if said at least one invoice document is not within said predetermined rules.

35. The system of claim 34, wherein said processor is additionally programmed to: obtain a first signal and invoke a dispute mechanism or obtain a second signal and invoke a payment mechanism.

36. The system of claim 35, wherein said processor programmed to invoke a dispute mechanism includes: a process for placing the issuer of said at least one order document into communication with the issuer of said at least one invoice document, and a process for indicating the status of said dispute.

37. The system of claim 35, wherein said payment mechanism includes an electronic settlement.

38. The system of claim 33, wherein said processor programmed for analyzing said at least one invoice document in accordance with said predetermined rules includes:
submitting said at least one invoice document to an approval process, if said at least one invoice document is within said predetermined rules.

39. The system of claim 38, wherein said processor programmed to perform said approval process includes determining if said invoice is suitable for payment.

40. The system of claim 39, wherein said processor programmed for determining if said at least one invoice is suitable for payment, includes, moving said invoice to an electronic settlement mechanism, if said invoice is suitable for payment.

41. The system of claim 39, wherein said processor programmed for determining if said at least one invoice is suitable for payment includes invoking a dispute mechanism if said invoice is not suitable for payment.

42. The system of claim 41, wherein said dispute mechanism includes: a process for placing said intended recipient of said invoice document into communication with the issuer of said invoice document, and a process for indicating the status of said dispute.

43. A computer-usable storage medium having a computer program embodied thereon for causing a suitably programmed system to integrate documents in a marketplace environment by performing the following steps when such program is executed on said system:
maintaining a database of at least one representation corresponding to an order document from a purchaser enterprise system;
maintaining a database of at least one representation corresponding to an invoice document from a supplier enterprise system;
reconciling said at least one representation of said at least one order document and said at least one representation of said invoice document; and
invoking an approval process or a dispute mechanism in response to said reconciliation of said at least one representation of said at least one order document and said at least one representation of said invoice document.

44. The computer-usable storage medium of claim 43, wherein said approval process includes the step of: invoking a payment mechanism or invoking a dispute mechanism.

45. The computer-usable storage media of claim 44, wherein said payment mechanism includes an electronic settlement.

46. The computer-usable storage media of claim 44, wherein said dispute mechanism includes, a process for placing the issuer of said at least one order document into communication with the issuer of said at least one invoice document.

47. A method for creating an invoice comprising:
obtaining at least one order document including at least one line item; electronically selecting at least one line item from said at least one order document to be used on said invoice; and
electronically transferring said at least one line item into an invoice template.

48. The method of claim 47, wherein said at least one line item includes a plurality of line items.

49. The method of claim 47, wherein said at least one order document is created outside of a marketplace environment.

50. A system for integrating documents comprising:
a storage device; and
a processor programmed to:
maintain in said storage device a representation corresponding to at least one order document including at least one line item;
select at least one line item from said at least one order document to be used on said invoice; and
transfer said at least one line item into an invoice template.

51. The system of claim 50, wherein, said at least one line item includes a plurality of line items.

52. The system of claim 50, wherein said at least one order document is from outside of a marketplace environment.

53. A computer-usable storage medium having a computer program embodied thereon for causing a suitably programmed system to create an invoice document in a marketplace environment by performing the following steps when such program is executed on said system:
maintaining a representation corresponding to at least one order document including at least one line item;
selecting at least one line item from said at least one order document to be used on said invoice; and
transferring said at least one line item into an invoice template.

54. The computer-usable storage medium of claim 53, wherein said at least one line item includes a plurality of line items.

55. The computer-usable storage medium of claim 53, wherein said at least one order document is from outside of a marketplace environment.
